(19) United States
(12) Patent Application Publication
(10) Pub. No.: US 2008/0071424 A1
(43) Pub. Date: Mar. 20, 2008

(54) PROGRAMMABLE POSITIONAL LIQUID FLOW SENSING DEVICE

(75) Inventors: James W. St. Jean, Meredith, NH (US); David D. Reynolds, Gilford, NH (US); Seth H. Richards, Meredith, NH (US); Wayne H. Sanborn, Meredith, NH (US)

Correspondence Address: AQUILLA PATENTS & MARKS, PLLC, 221 COE HILL ROAD, CENTER HARBOR, NH, 03226-3605, US

(73) Assignee: PROTAP DESIGN, LLC, Meredith, NH (US)

(21) Appl. No.: 11/532,769

(22) Filed: Sep. 18, 2006

(51) Int. Cl. G06F 17/00

(52) U.S. Cl. 700/282; 700/283; 700/244

(57) ABSTRACT

A positional flow sensing device includes an accelerometer or inclinometer with user readable indicators for tracking information associated with a succession of fluid flow events. The fluids can be any fluid that it may be desirable to monitor the dispensing of, such as beer, other beverages, or oil. Each fluid flow event volume is calculated based on control valve positional information, upon which the positional flow sensing device is installed. The positional flow sensing device is operatively coupled to a user interface having a display and grouping of switches arranged to provide to the user fluid volume related information during and after each fluid flow event.

### BACKGROUND OF THE INVENTION

1. Field of the Invention

The present invention relates to flow sensing devices for calculating flow volume from fluid control valve positional information. More particularly, the invention pertains to a method and apparatus for sensing the position of the control valve for tabulating information related to the amount of liquid dispensed from a fluid dispensing system.

2. Description of Related Art

Although the present invention finds specific utility in connection with beer or other beverage dispensers, it will be appreciated that the present invention also is amenable to other dispensing devices having a valve actuator, which is movable along a predetermined path.

The management of beverages and the collection of the corresponding receipts relative to the operation of a bar and/or restaurant poses many problems for owners and management persons of such establishments. One such problem involves the attainment of a reasonable correspondence between the amount of beverage poured and the cash received by the establishment for the poured beverage. In many bars and restaurants, beverage is liberally poured and many drinks may be provided free of charge. It has therefore been difficult for management to maintain an accurate relationship between the amount of beverage used relative to the net income of the establishment. While the cost of each container or beverage is relatively inexpensive to the operator of the bar or restaurant, the overall expenses, including labor, overhead, and lost income from wasted beverage necessitate a substantial charge for each drink. Thus, the profit involved in the operation of the bar or restaurant depends on accurate charging and maintenance of receipts relative to the corresponding beverage poured and served to customers.

The use of devices to monitor and indicate the amount of liquid remaining in a liquid holding container is known in the art. This is especially true for liquor dispensing and measuring devices. One type of measuring device, specifically used for determining liquid content in kegs or barrels, is exemplified by U.S. Pat. No. 5,511,694 to Rohm. These (Rohm) type devices do not contact or directly monitor the liquid contents being dispensed. Instead, a simple on-off position sensitive (e.g., mercury) switch is employed to indicate when a valve or tap suitably coupled to the container is open. Thus, the Rohm type systems provide only approximate estimates as to how much liquid “remains” in the container, and are no help in accurately determining how much liquid is actually dispensed and how many drinks are provided. Importantly, these systems (and equivalents) are inaccurate for several reasons. First, the volume of liquid or fluid dispensed is indirectly determined via a time measurement. For example, Rohm employs an on-off mercury or tilt switch to determine when a tap handle on the keg is in an open position. However, liquid will flow from the keg at a slower rate, when the tap is only half (or partially) open. As such, devices like Rohm's may not detect that the valve is (partially) open, or may detect it by assuming the valve is fully open. Accuracy is also affected by the fact that the pressure, and therefore the flow rate, may vary considerably with such pressurized containers.

As will be explained below, the present invention involves a tap handle, a display means located therein, a power source, a microprocessor which has timing capability or some associated independent timer means, and an analog position-sensitive device, such as an accelerometer. Tap handles are known. Display means are known, both in general and in a small size. Small power sources (batteries) are known. Microprocessors are known. Analog sensors per se are known in general. Thus, the particular individual components of apparatus required for the practice of the present invention are known, however, the combination of an accelerometer analog position-sensitive device connected to a tap handle, alone or with the other associated equipment provided in accordance with the present invention, is believed to be novel and unobvious, as is also the idea of combining such equipment as a way of providing a solution to the particular problem which the present invention addresses.

### SUMMARY OF THE INVENTION

The present invention provides an improved valve position sensing method using an accelerometer or inclinometer to be used to determine volume dispensed through the valve. Information from this position sensing device can be used with a reasonable accuracy to determine the volume of liquid dispensed, by way of a position sensor, such as this accelerometer or inclinometer analog position sensor, and other factors including container pressure, beverage supply line size and length, and calibrated time duration, and the number of times the device is removed from the opening of the container (i.e., for container changing). Also, user-readable tabulated data can be provided with a reasonable accuracy indicating total fluid flow information in known container size(s).

Briefly stated, a dispensing device is provided with an accelerometer or inclinometer analog positional sensing device to provide flow rate information for tracking data associated with a succession of pouring events of a liquid, upon which the positional sensing device is installed. Each respective pouring event volume is calculated using valve position information, container pressure, supply line diameter, supply line length, hardware and software filtering techniques, and other factors to determine the volume of liquid dispensed from the container, and pouring related information, such as a total number of pours since a defined event, a cumulative monetary value of the pours since a defined event, a total number of pours since a reset operation, a total monetary value of the total number of pours since a reset operation, a number of disconnects of the dispensing device from respective containers, pouring events by container size, categorized pouring events during an employee shift, categorized pouring events during any predetermined time period etc., to be collected and suitably made available to a user.

The fluid measuring system includes an accelerometer or inclinometer analog positional sensing device adapted for coupling with a mechanical attachment to the liquid dispensing valve, a communication method to convey valve analog positional information to a control unit, and program instructions or routines (which optionally are represented in software, hardware, firmware, or any combinations thereof) to convert this information to fluid volume. This fluid measuring system is operatively coupled to the controller to indicate when a pouring event commences, valve positional information, and when a pouring event terminates.

A user interface is further provided to enable the exchange of information between a user of the fluid measuring system and the controller. The user interface is also operatively coupled to the controller, thereby enabling a user to input information to the fluid measuring system, and to enable the user to receive information from the fluid measuring system. The user interface is suitably attached to the controller to enable a user easy access to preferred components thereof, including input and output devices.

A full understanding of the present invention, including an understanding of a number of capabilities, characteristics, and associated novel features, will result from a careful review of the description and figures of several embodiments provided herein. Attention is called to the fact, however, that the drawings and descriptions herein are illustrative only. Variations and alternate embodiments are contemplated as being part of the invention, limited only by the scope of the appended claims.

### BRIEF DESCRIPTION OF THE DRAWING

The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows.

FIGS. 1a and 1b is a functional block diagram of a positional flow sensing apparatus according to an exemplary embodiment of the present invention.

FIG. 2 is a description of the accelerometer or inclinometer operation.

FIG. 3 is a front and side view of a preferred embodiment of the accelerometer or inclinometer analog valve positional measuring device. The positional measuring device is shown suitably installed upon and coupled to a liquid dispensing valve.

FIG. 4 is a view of the analog sensor printed circuit board.

FIG. 5 is a mechanical diagram of the valve positional measuring device.

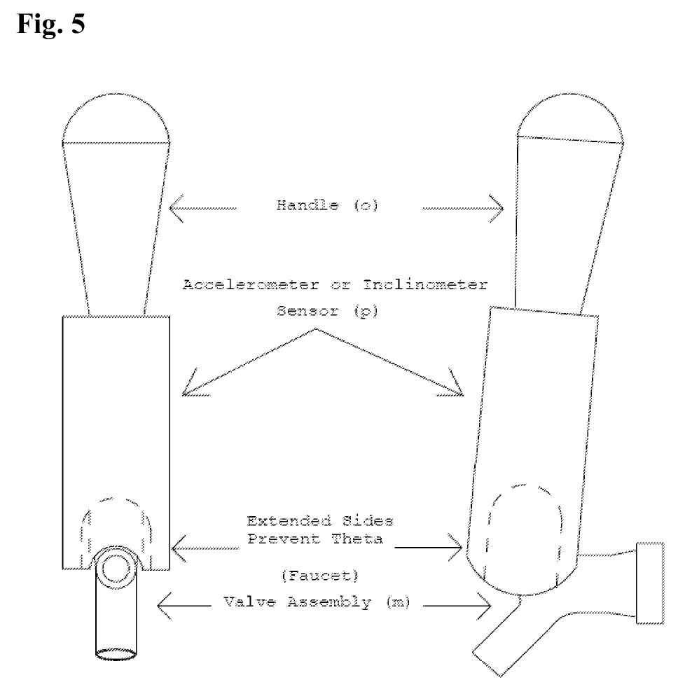

### DETAILED DESCRIPTION OF THE INVENTION

It is important to establish the definition of a number of terms and expressions that will be used throughout this disclosure. The terms “liquid holding container” and “container” indicate any liquid holding method, such as a bottle, jug, barrel, keg, etc., from which a fluid can be dispensed, unless it is otherwise apparent from the context. A “Pouring Event” occurs when the faucet handle is moved from the closed position to open and back to closed again. Thus, a pouring event is initiated each time the dispensing valve is moved from the closed position to an open or partially opened position. Other important terms and definitions will be provided, as they are needed, to properly and concisely define the present invention and its associated novel characteristics and features.

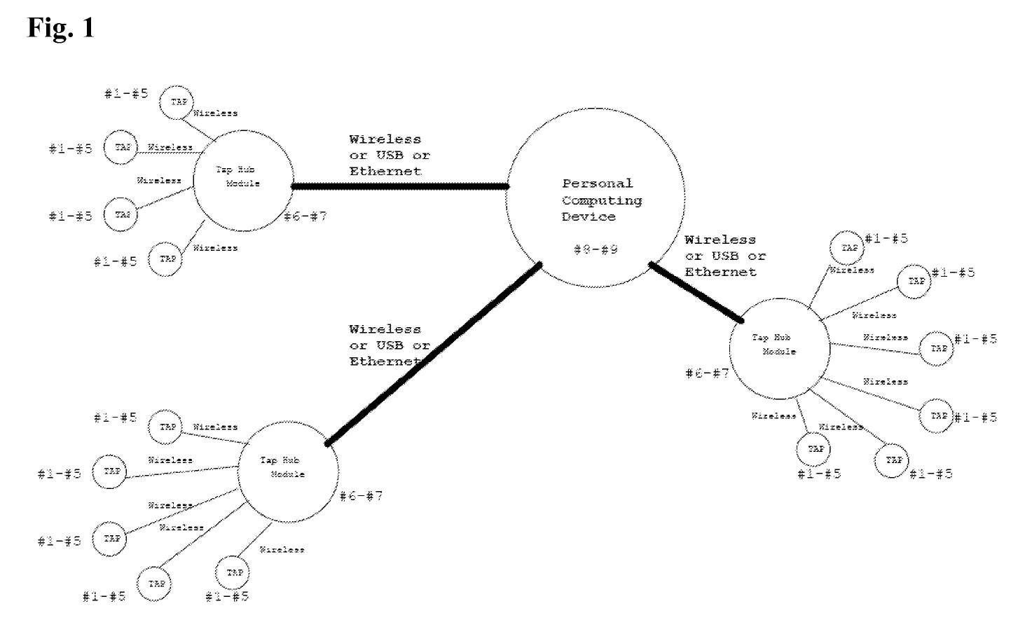

Referring now to FIG. 1a and FIG. 1b, a block diagram of an embodiment of the invention is illustrated. A sensor unit includes a local controller unit 1, such as a microprocessor, microcontroller, or an optionally programmable controller or embedded controller. Alternately (and providing the equivalent functionality), a finite state machine is provided as the controller unit, e.g., which may be realized by a programmable logic device (PLD), field programmable gate array (FPGA) or field programmable object arrays (FPOAs).

The local controller 1 is operatively coupled to a flow detector analog positional sensor 2, for determining when pouring is not occurring, when a pouring event is in progress, and the flow control valve positional information.

The output of the position sensor 2 is periodically sampled by using the timer 4 and detected by the local controller 1. In the preferred embodiment, the analog or digital output of the position sensor 2 is input to the microcontroller 3 using analog-to-digital converters. However, it will be recognized that in other embodiments, digital information from the analog position sensor 2, can be passed to the processor as digital data.

The local controller 1 is operatively coupled to a Communication Unit 5 to convey the positional information to a Tap Hub Module 6 using the Communication Master Unit 7.

The Communication Master Unit 7, and/or the Tap Hub Module 6 thereof, communicates with a Personal Computing Device 9, to receive and display information for viewing by a user. The Personal Computing Device 9 is operatively coupled to the Tap Hub Module 6 using optional communication methods, such as Ethernet, USB, or Wireless methods. The Tap Hub Module 6 may also provide communications through a Removable Storage Device 8. This device may be in addition to the other communication methods.

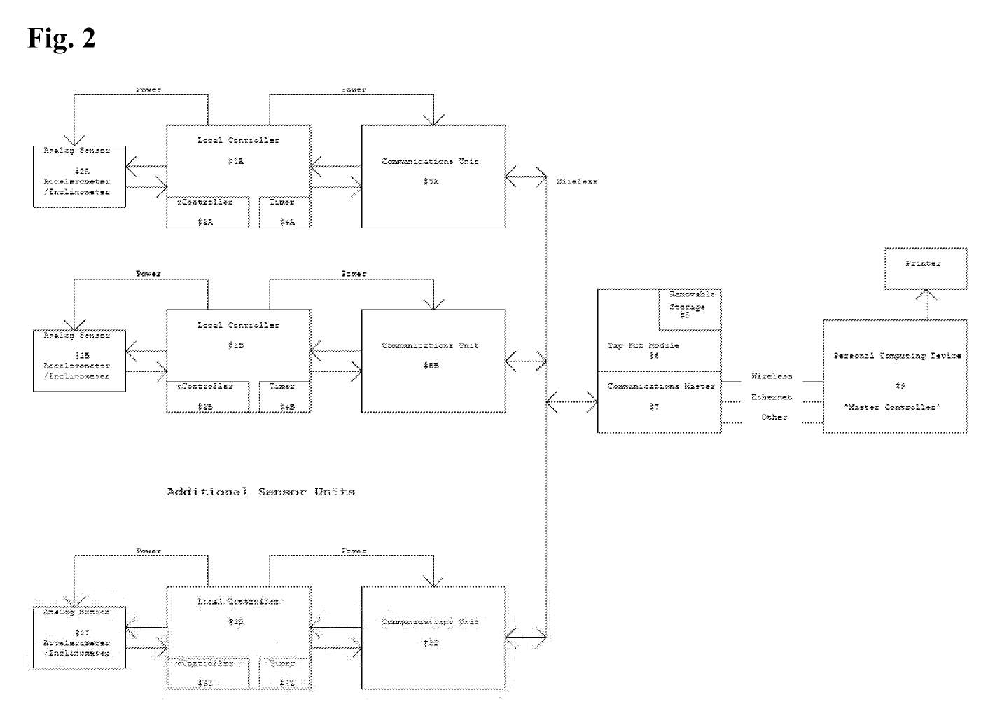

The accelerometer or inclinometer analog positional sensing device of the present invention has an output voltage, which is related to the position of the analog sensing device and its relation to the gravitational force g. Since the position indicator element shown in FIG. 2 is mounted on the flow control valve, and thus moves in relation to the gravitational force g, the valve position can be determined. The voltage output will change as the valve position is changed, since the sensing mechanism is mechanically coupled to the flow control valve. If the accelerometer or inclinometer is mounted in such a way that the X and Y axis are perpendicular to the valve control handle, then the component of gravity measured will be ±1 g when the handle is vertical and move towards 0 as the handle becomes parallel to the gravitational force. In this embodiment the valve handle is expected to traverse only ±15 degrees from vertical. In this range one can determine a very reasonable estimate of the g component, when the handle is moved. By using the sine of the angle formed between the handle and a plane perpendicular to the g force, the handle position can be found. It should be noted that other geometric formulas can be used, such as cosine, arcsine and others. Other embodiments without the ±15 degree constraint, such as an ale or lager faucet, are envisioned where similar mathematics will be required.

Since the movement of the handle can effect both the X and Y axis values, the magnitude of angular displacement is calculated using the square root of the sum of the squares of the X and Y values. This is not enough information, unless the closed position is at the vertical position of the handle, since it will only describe a curve that has a minima as it passes through vertical and two maxima at each lever extreme.

This can be solved by calculating using the squares of X-Xc and Y-Yc, where Xc is the value of the X axis when closed and Yc is the value of the Y axis when closed. Again, this calculation will only be valid if the sensing unit is not allowed to rotate. A rotational change can be detected by noting a magnitude change from Xc and Yc, when the handle is in the closed position. Software can be used to detect this situation and resetting the Xc and Yc values.

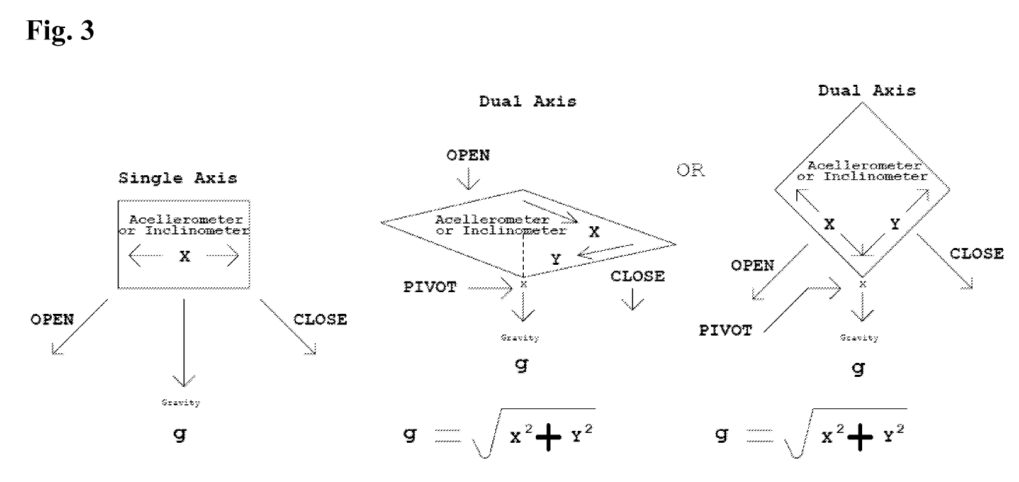

The positional flow sensing device is advantageously employed in conjunction with a liquid dispensing device, such as beer or other beverage, oil, etc. Referring now to FIG. 3, an exemplary valve assembly m is shown with a liquid dispensing device, which includes a movable valve actuator n, such as a beer tap handle, with the position sensing indicator element carrier thereon. The handle o is movable between a closed and fully open position and the position sensor p is mounted in fixed position on the moveable valve handle. The state of the position sensor p will vary with relation to the gravitational force g as it moves from the closed position (minimum proximity to the sensor in the depicted embodiment) and fully open position (maximum displacement in the depicted embodiment). In this manner, the sensor p state can be used to determine the location of the handle o along its path of travel. Of course, other arrangements are also possible, such as multiple axis positioning sensors and indicator elements, such that the position is proportional or inversely proportional, when the handle o is toward the fully open position, or when the handle is moved toward the closed position. Likewise, arrangements are also contemplated wherein the indicator elements are mounted in such a manner that positional information can be obtained in any orientation of the sensing device.

The sensing device p can be, for example, an accelerometer sensing device, an inclination sensing device, or other similar devices measuring acceleration, velocity or gravitational forces.

The sensing device p communicates with the Tap Hub Module by any acceptable method to convey a pouring event. In this preferred embodiment the method of communication is through a wireless connection. The Tap Hub Module communicates to the Personal Computing Device to enable the exchange of information between The Personal Computing Device and the local controller. The user interface is preferably a custom software application on the Personal Computing Device. This software application is coupled to the Tap Hub Module and Local Controller thereby enabling a user to input information to the fluid flow measuring system and receive information therefrom.

The Personal Computing Device 9, which may be termed a “master controller,” may be provided in a microprocessor-based “programmed” embodiment, such as a finite state machine provided via a programmable logic device, and is arranged to determine the volume of fluid dispensed when a pouring event occurs, or alternately a standard personal computer running a custom software application. In addition, it is contemplated that the master controller may further be employed to tabulate pouring event data and categorize this data for the user. For example, the tabulated data may be used to provide quantity of fluid dispensed, and categorized by container and/or type of fluid, during a specified duration. Optionally the information may be made available to a printer or other data communication interface.

Once the Personal Computing Device has determined the pouring event has concluded, the fluid volume information will be calculated and categorized totals will be updated. As discussed, the pouring related information may include a “total number of pours”, since a defined event, and also a “cumulative monetary” value or total for all the pours, since a defined event.

A defined event may be entered into the local controller, when a user inputs a pre-determined event sequence of switch presses. The sequence of switch presses may be provided to the local controller by way of switches, switches and display selection, or keypad, and will cause certain information (e.g., association between valve and beverage or fluid type or brand, event definitions, such as cleaning or service, etc.) to be defined or set to a desired initial value. Similarly, a defined event, initiated in an equivalent manner, may be assumed to reset other items or counts, including a number of categorized pours from the container.

As discussed above, prior art dispensing devices have significant accuracy concerns and problems. One drawback that arises with low cost dispensers, such as the device disclosed in U.S. Pat. No. 4,436,223, to Wilson, is caused by attempting to time a pouring event with a fixed (time) duration limit. The timing of a pouring event to determine volume can be accurate only so long as the flow rate is constant. However, when considering a container of the type to which the present invention may be applied, the flow rate may decrease as liquid is dispensed and the volume of liquid in the container decreases. That is, when a liquid holding container is full, or nearly full, liquid flow rate may be at a peak. Then, as the container empties, the rate may decrease, e.g., due to a decrease of pressure upon the liquid at a dispensing location.

As a result, the period of time required to dispense a pre-selected and uniform volume of liquid (with each pouring event) may be shorter when the container is full than it would be when the container is half full or nearly empty. Accordingly, a table of correction values, e.g., in a look up table or other digital storage device, may be determined, e.g., as a function of the type and size of the dispensing container, as well as other parameters and particulars, and be made available as needed to adjust the volume calculation for a pouring event.

For example, after one or some other preselected number of pouring events have occurred, a value contained in the table may be modified to more accurately determine the calculated volume for the next one or more pouring events. Therefore, to provide for a more accurate correlation between the parameters of a pouring event and a volume of liquid that is poured from the container during a pouring event, the controller may be configured (e.g., via a dynamic table lookup) to adjust the calculated volume of a pouring event, as a succession of spaced pouring events occur, and the container is emptied.

Thus the instantaneous rate of flow from a fluid control valve supplied by a pressurized fluid containment vessel (such as a beer keg) is affected by factors additional to the physical position of the fluid control valve. Along with the position of the fluid control valve, the method used to determine the instantaneous rate of flow of the fluid from the valve takes into account how much fluid was dispensed during the previous pouring event and the time elapsed since that last pouring event. The maximum instantaneous flow rate calculated during the current pouring event is at its lowest, when the previous pouring event is large in volume and near in time. As the elapsed time between the previous pouring event and the current pouring event increases to a certain duration (determined by the volume of the previous pouring event and the volume of fluid remaining in the pressurized fluid containment vessel) the maximum instantaneous flow rate calculated reaches the maximum the particular vessel-control valve combination is capable of.

It has also been observed that the instantaneous flow rate from a fluid control valve supplied by a pressurized containment vessel varies during the duration of a single pouring event. The instantaneous flow rate is at its maximum (as determined by the factors described in the previous paragraph) at the beginning of the pour event and decreases, perhaps to a minimum determined by the physical aspects of the dispensing system described in paragraph 0007, over the course of the pouring event. As such, the duration of the current pour is also taken into consideration, when calculating the instantaneous flow rate that is used to determine the total volume of the current pouring event.

The following steps are used to determine the instantaneous flow rate during a pouring event:
1) Calculate the initial instantaneous flow rate for the pouring event, based upon the physical system characteristics described in paragraph 0007.
2) Adjust the initial instantaneous flow rate, based upon the volume and duration of the previous pouring event, the time elapsed since the previous pouring event, the volume of liquid remaining in the fluid dispensing vessel, and the sensed position of the fluid control valve.
3) As the current pouring event progresses, adjust the calculated instantaneous flow rate, based upon the sensed position of the fluid dispensing valve, the duration thus far of the current pouring event, and the volume dispensed thus far during the current pouring event.

The volume poured during each fluid control valve position sensing period is determined by multiplying the instantaneous flow rate at the time of the sample by the length of the sample period. The volume poured during a pouring event is determined by summing the volume poured during each sample period of the pouring event.

### Theory of Operation

The positional flow sensor device is used to determine the position of a draft beer faucet handle. The sensor preferably comprises a multi-axis accelerometer coupled to a microcontroller, both preferably powered by on-board batteries. As the handle is opened or closed, the analog voltage outputs of the accelerometer increase or decrease, based upon the physical acceleration of the accelerometer and the change in the measured gravitational acceleration along the axes.

By focusing on the change in the measured acceleration of gravity, the position of the faucet handle relative to known closed and vertical positions can be determined (see sections below on calibration, filtering, and determining handle position for more detail).

Though the resulting ‘angular displacement’ values are more accurately calculated as though they are on the surface of a sphere (i.e., sin(−15°<θ_{Angular Displacement}<+15°)), the straight-line calculation of distance in a Cartesian plane utilized by the accelerometer results in a full-scale error of less than ±0.5% for θ_{Angular Displacement}<±15°. The benefit of the straight-line interpolation is the removal of all trigonometric functions from the software, saving hundreds of computation cycles.

### Factory Calibration

Factory calibration is performed prior to installation of the accelerometer. The goals of factory calibration are to:
Determine the X- and Y-axis accelerometer outputs, when the device is vertical; and
Calculate differences in sensitivity between the X- and Y-axes of the accelerometer.
   1. Place the accelerometer in the calibration jig and orient the jig so the device is vertical.
   2. Instruct the microcontroller to record the current X- and Y-axis values from the accelerometer as X_{vertical} and Y_{vertical}.
   3. Tilt the jig to 15° in the +X direction. Record the X reading as calXₘₐₓ.
   4. Tilt the jig to 15° in the −X direction. Record the X reading as calXₘᵢₙ.
   5. Tilt the to jig 15° in the +Y direction. Record the Y reading as calYₘₐₓ.
   6. Tilt the jig to 15° in the −Y direction. Record the Y reading as calYₘᵢₙ.
   7. Calculate and record the geometric eccentricity of the X- and Y-axes of the accelerometer as:

$$axisEccentricity = \frac{calXmax - calXmin}{calYmax - calYmin}$$

### Installation Calibration

Because of the mechanical differences from faucet to faucet and electrical and mechanical differences from accelerometer to accelerometer, it is necessary to adjust each accelerometer to the particular faucet on which it is mounted.

The ‘Installation Calibration’ process is used to discover the mechanical attributes of the faucet, e.g. the faucet closed position as detected by the accelerometer installed on the faucet. The calibration process also allows for the compensation of differences in sensitivity between the X- and Y-axes of the accelerometer, using the axisEccentricity calculated during Factory Calibration. Finally, installation calibration provides offset and gain values for both axes that allow the accelerometer samples to be scaled into an optimal range.
1. Install the accelerometer on a closed faucet.
2. Record the X-axis value as X_{closed} and the Y-axis value as Y_{closed}.
3. Open the beer faucet.
4. Record the X-axis value as Xₒₚₑₙ and the Y-axis value as Yₒₚₑₙ.
5. Calculate the distance from the closed position to the vertical position as:

$${closedToVertical}_{perfect} = \sqrt{\begin{matrix}{( {X}_{closed} - {X}_{vertical} )}^{2} + \\ {( ( {Y}_{closed} - {Y}_{vertical} ) \cdot axisEccentricity )}^{2}\end{matrix}}$$

The application of axisEccentricity to the Y factor compensates for differing sensitivities on the X- and Y-axes. The result is the distance from closed to vertical with the axes scaled to the same sensitivity.
6. Calculate the adjusted distance from the closed position to the vertical position as:

$${closedToVertical}_{actual} = \frac{{closedToVertical}_{perfect}}{axisEccentricity}$$

The application of axisEccentricity in this calculation alters the calculated distance to reflect the differing sensitivities of the X- and Y-axes.
7. Calculate the distance from the open position to the vertical position as:

$${openToVertical}_{perfect} = \sqrt{\begin{matrix}{( {X}_{open} - {X}_{vertical} )}^{2} + ( ( {Y}_{open} - {Y}_{vertical} ) \cdot \\ {axisEccentricity )}^{2}\end{matrix}}$$

The application of axisEccentricity to the Y factor compensates for differing sensitivities on the X- and Y-axes. The result is the distance from closed to vertical with the axes scaled to the same sensitivity.
8. Calculate the adjusted distance from the open position to the vertical position as:

$${openToVertical}_{actual} = \frac{{openToVertical}_{perfect}}{axisEccentricity}$$

The application of axisEccentricity in this calculation alters the calculated distance to reflect the differing sensitivities of the X- and Y-axes.
9. Calculate the projected maximum X-axis sample value and maximum yaxis sample value:

$${X}_{max} = Xvertical + max ( open To {Vertical}_{perfect} , {closedToVertical}_{perfect} )$$

$${Y}_{max} = Yvertical + max ( open To {Vertical}_{actual} , {closedToVertical}_{actual} )$$

where max(a,b) returns the larger of a and b.
10. Calculate the projected minimum X-axis sample value and minimum Y-axis sample value as:

$${X}_{min} = Xvertical - max ( open To {Vertical}_{perfect} , {closedToVertical}_{perfect} )$$

$${Y}_{min} = Yvertical - max ( open To {Vertical}_{actual} , {closedToVertical}_{actual} )$$

where max(a,b) returns the larger of a and b.
11. Calculate the offset for the X- and Y-axis as:

$${offset}_{X} = {X}_{min} - guardValue$$

$${offset}_{Y} = {X}_{min} - guardValue$$

where guardValue is an integer sufficiently large to guarantee that an actual sample will not fall outside the projected range, but not so large that offsetX and offsetY become negative.
12. Calculate the projected total sample range of the X- and Y-axes as:

$${range}_{X} = ( 2 \cdot guardValue ) + ( {X}_{max} - {X}_{min} )$$

$${range}_{Y} = ( 2 \cdot guardValue ) + ( {Y}_{max} - {Y}_{min} )$$

13. Calculate the gain value for the X- and Y-axes as:

$${gain}_{X} = \frac{{2}^{15} - 1}{rangeX}$$

$${gain}_{Y} = \frac{{2}^{15} - 1}{rangeY}$$

### Accelerometer Sample Scaling

As noted above, the goal of installation calibration is to tailor the values used to scale samples provided by a particular faucet-accelerometer pairing. This section illustrates how the values calculated during installation calibration are used to manipulate the raw X- and Y-axis samples so they fall within the range acceptable by the algorithms that analyze them.

The current algorithms require that the X- and Y-samples fall between 0 and 127 inclusive.
1. Acquire the 10-bit samples for the X- and Y-axis from the accelerometer.
2. Shift the raw X sample down into the proper range by subtracting the X offset:

sample_{X}=X_{raw}−offset_{X}
3. If sample_{X}<0, set sample_{X}=0 and skip to step 5. If sample_{X}>127, set sample_{X}=127 and skip to step 5.
4. With 0≦sample_{X}≦127, set sample_{X}=msb(sample_{X}·gain_{X}) (where msb(a) returns the most significant 8 bits of a 16 bit value).
5. Shift the raw Y sample down into the proper range by subtracting the Y offset:

sample_{Y}=Y_{raw}−offset_{Y}
6. If sample_{Y}<0, set sample_{Y}=0 and skip to step 8. If sample_{Y}>127, set sample_{Y}=127 and skip to step 8.
7. With 0≦sample_{Y}≦127, set sample_{Y}=msb(sample_{Y}·gain_{X}) (where msb(a) returns the most significant 8 bits of a 16 bit value).
8. Proceed to the sample filtering stage.

### Filter

Before the position of the tap handle can be determined, the scaled values samplex and sampley need to be filtered.

The samples are filtered in two (2) independent streams, one for the X-axis and the other for the Y-axis. The filter used is a low-pass finite impulse response (FIR) with 16 coefficients optimized for a 25 Hz sample rate and a 4 Hz cut-off frequency.

Filtering serves two purposes. The first, and most obvious, is to remove noise from sample streams. The software algorithms that determine the position of the faucet handle would be adversely affected by random noise in the data streams, and thus this noise must be filtered from the streams. The second reason is counter-intuitive, but important nevertheless. By definition, accelerometers measure acceleration. As the tap handle is opened or closed, its acceleration is indicated by high-frequency spikes in the X- and Y-data streams. Since our device is solely interested in the position of the handle and not its movement, the high frequency components of linear acceleration must be removed from the data stream as well.

By removing noise and the linear acceleration the resulting X_{filtered} and Y_{filtered} represent the acceleration due to gravity on the axes of the accelerometer. As the tap handle changes position, the angle between the axes of the accelerometer and the vector of gravitational acceleration change as well. The change in angle results in changes in X_{filtered} and Y_{filtered}. The position of the tap handle in relation to the calibrated vertical position and the calibrated closed position can be determined based on these changes.

### Determining Handle Position

The distances from the calibrated vertical and closed positions are used to ascertain the current position of the tap handle. These distances are calculated every time a new set of X- and Y-axis samples is taken from the accelerometer (25 times per second).

### Distance from Calibrated Closed Position

The distance from the current position to the calibrated closed position indicates the “openness” of the faucet. As the handle is moved to the open position, distanceFromClosed increases. Conversely, distanceFromClosed decreases to zero, as the tap handle is moved from the open position to the closed position.

distanceFromClosed=\sqrt{(X_{filtered}−X_{closed})²+(Y_{filtered}−Y_{closed})²}

### Distance from Calibrated Vertical Position

As the tap handle is moved from the closed position to the open position, distanceFromVertical decreases to zero, until it reaches the calibrated vertical position. As the handle is moved beyond the vertical position, distanceFromVertical increases from zero, until the handle reaches the open position. It follows that, as the faucet handle is moved from the open position to the closed position, distanceFromVertical again decreases to zero, until the vertical position is reached, and increases as the handle moves beyond vertical to the calibrated closed position.

Considered alone, distanceFromVertical provides no information about the “openness” of the faucet; it only indicates how far from vertical the handle is located, which could be either in the closed direction or in the open direction. Considering distanceFromVertical and distanceFromClosed together, however, expresses the nature of the tap movement.

Since the accelerometer is installed by screwing it onto the threaded faucet lever, it is possible that rotational movement could be detected. When the accelerometer is being rotated (e.g., being screwed in or unscrewed, intentionally or unintentionally), distanceFromClosed increases or decreases, mimicking the opening or closing of the faucet. During rotational movement, however, distanceFromVertical remains constant. Thus, rotational motion can be described (and detected) as a change in distance from the closed position without a change in distance from the vertical position. “Open-Close” movement can be described (and detected) as a change in distance from the closed position with change in distance from the vertical position.

distanceFromVertical=\sqrt{(X_{filtered}−X_{vertical})²+(Y_{filtered}−Y_{vertical})²}

### Alternate Method #1 for Rotational Compensation

If the current angle of rotation from a fixed datum can be continuously monitored and if the distanceFromVertical of the closed faucet position is known, the current position in the complete 360 degree arc of closed_{X} and closed_{Y} pairs can be easily calculated with a polar to rectangular coordinate transformation engine. The angle can be determined by measuring the current linear displacement along the shared axis of the accelerometer and the screw that it is mounted on. As the accelerometer is rotated on the screw, this displacement changes in a fashion that is directly related to their angular displacement.

### General Implementation

The linear displacement can be monitored by a device that measures the distance between the top of the screw and any fixed datum within the accelerometer. This device can be any device or method that converts a displacement to a corresponding voltage, such as, for example, a strain gauge, optical sensor, linear potentiometer, encoder, anisotropic magnetoresistance bridge, Hall effect sensor, etc.

The magnitude of the displacement is converted to a digital count. The number of counts per complete turn and the rotational fixed datum are determined in two separate calibration procedures. The current count is converted to angular displacement using scaling, offset and Modulo arithmetic. This angle, the closed distanceFromVertical and the rectangular coordinates of Vertical are used to calculate the current closed_{X} and closed_{Y} coordinates.

### Specific Implementation

A permanent magnet is placed on a spring-loaded rod (or any type of probe) that extends through a hole along the axis of the threaded accelerometer mount receiver. This probe rests on and responds to the top of the faucet screw. The magnet indicates linear position by moving in relation to an AMR (Anisotropic Magnetoresistance) displacement sensor (currently a Honeywell HMC1501). This sensor has an embedded Wheatstone bridge whose output is amplified by a differential amplifier. The output of the amplifier is connected to an A/D input on the embedded microprocessor or finite state machine.

### Calibration Steps

Counts per turn (gain_{T}) is determined at Factory Calibration and is currently done by stepping the screw through five turns and taking the average of the difference of counts between turns. The datum is determined at installation calibration. The accelerometer is installed on its faucet in an arbitrary rotational but closed position and a reading (closed_{X} and closed_{Y}) is recorded as well as a corresponding reading on the turn sensor (closed_{T}). The datum is calculated using the following math:

Prescale the X and Y readings and subtract the Vertical X and Y positions from them:

PS0ClsdX=PSclosedX−PSvertX

PS0ClsdY=PSclosedY−PSvertY

Dist_from_Vert=ROUND(SQRT((PS0ClsdX)̂2)+((PS0ClsdY)̂2)),0)

The center is now at the origin so we can find the angle that this pair determines:

Angle(radians)_from_{—}0=

IF((ATAN(PS0ClsdY/PS0ClsdX)>0),(ATAN(PS0ClsdY/PS0ClsdX)),(ATAN (PS0ClsdY/PS0ClsdX)+(2*3.14159))) or

IF((PS0ClsdY>0),(ACOS(PS0ClsdX/Dist_from_Vert)),((2*3.14159)−ACOS(PS0ClsdX/Dist_from_Vert)))

Scale the result so its possible range is from 0-255:

Angle(MOD256)=ROUND(Angle(radians)_from_{—}0*255/(2*3.14159),0)

This result leaves us with a number that is appropriate for use in a 256 element lookup table. The 0Datum_Count is a value where 0 degrees resides in the Modulo(gainT) environment:

0Datum_Count=closedT−ROUND((Angle(MOD256)/256)*gainT,0)

### Run-Time Calculations

The current T is read and (using the Dist_from_Vert), converted into a new PSClosedX and PSClosedY that can be used with the current prescaled and filtered X,Y readings to calculate the new distanceFromClosed value. PSClosedX and PSClosedY are calculated using the following math:
Find the current distance from 0 degrees:

Current_OffsetT=countT−0Datum_Count
This must be scaled into a Modulo 256 context:

Offset(MOD256)=LSB_{—}OF(gainT*Current_OffsetT/256)
This result is a number that can be used as an offset address into a 256 element sine/cosine lookup table.

PS0ClsdX=Dist_from_Vert*Cosine [Offset(MOD256)]

PS0ClsdY=Dist_from_Vert*Sine [Offset(MOD256)]
These are the X and Y values relative to the origin. They now must be translated to the positions on the plane relative to vertical.

PSClosedX=PS0clsdX+PSvertX

PSClosedY=PS0clsdY+PSvertY

### Alternate Method #2 for Rotational Compensation

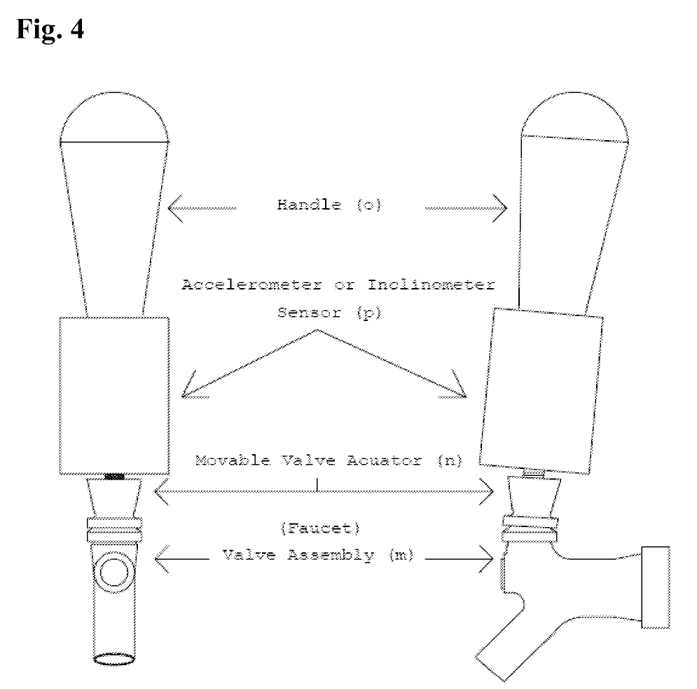

If the mechanical position of the sensor can be prevented from rotating, the rotational compensation will not be required. This can be accomplished by extending the housing of the sensor so that it can not rotate, once placed on the faucet handle. This implementation is shown in FIG. 4. This also allows a single axis accelerometer to be used to indicate the position of the faucet handle. This is only true if the angle of motion is limited from the closed position to the open position. Since a Stout faucet has a motion of greater than 90 degrees, the current embodiment may use a dual axis so the same circuit can be used for multiple faucet configurations.

In order to not obfuscate the essential functional and operational characteristics of the embodiments of the present invention as illustrated, certain items have been omitted. For example, the inclusion of a power source, such as a (optionally rechargeable) battery and a power regulator, has been omitted in FIG. 1. Items such as this, or others and equivalents thereof, which have been excluded in FIG. 1, may certainly be provided by skilled persons.

It must further be understood that the architectural and operational embodiments described herein are exemplary of a plurality of possible arrangements to provide the same (or equivalent) general features, characteristics, and general system operation. Therefore, while there have been described the currently preferred embodiments of the present invention, those skilled in the art will recognize that other and further modifications may be made, without departing from the spirit of the present invention, and it is intended to claim all modifications and variations as fall within the scope of the appended claims.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A fluid flow measuring system for calculating fluid flow volume of a fluid dispensing apparatus during fluid dispensing operations, said fluid flow measuring system comprising:
a) a positional flow sensing device operatively coupled to a control valve dispensing mechanism to provide control valve positional information, which can be converted to flow volume through transfer functions using any of the following information: gravitational force magnitude, beverage container pressure, supply line diameter to control valve mechanism, specific gravity of fluid, measured positional transfer function, or control valve mechanism positional information;
b) a local controller comprising means for receiving positional information from said positional flow sensing device, said local controller being operatively coupled to said positional flow sensing device to indicate fluid flow volume based on said control valve position;
c) a computing device and user interface for enabling a user to program said local controller and/or a tap hub module, and for calculating accumulated flow volume information;
e) said local controller, tap hub module, and personal computing device accumulating fluid flow volume data using positional information received from said positional flow sensing device to determine when a fluid flow event commences, control valve positional information during a fluid flow dispensing event, and, when a pouring event terminates, to tabulate fluid volume information into predetermined container sizes, providing the user tabulated fluid flow volume data via said user interface.

2. A fluid flow measuring system in accordance with claim 1, further comprising means for said user to print accumulated flow volume information.

3. A fluid flow measuring system in accordance with claim 1, wherein said system includes means for providing information when the device has been connected to and disconnected from said fluid control valve.

4. A fluid flow measuring system in accordance with claim 1, wherein said flow sensing device comprises a structure selected from a group consisting of:
i) an accelerometer operatively coupled to said control valve dispensing mechanism, and means for transfer of said control valve positional information to said local controller to indicate said control valve position; and
ii) an inclinometer operatively coupled to said control valve dispensing mechanism, and means for transfer of said control valve positional information to said local controller to indicate said control valve position.

5. A fluid flow measuring system in accordance with claim 4, further comprising:
a) a controller for converting said control valve positional information to allow fluid flow information to be placed in known container sizes; and
b) a hardware or software filter for removing acceleration from said control valve positional information.

6. A fluid flow measuring system in accordance with claim 5, wherein said positional flow sensing device is operatively connected to said control valve dispensing mechanism to enable the positional flow sensing device to provide control valve positional information for flow calculation.

7. A fluid flow measuring system in accordance with claim 5, wherein said positional flow sensing device uses the component of gravity along a plane defined by mechanical movement of said control valve to provide positional information for flow calculation.

8. A fluid flow measuring system providing user readable tabulated data, with a reasonable accuracy, indicating total fluid flow information in known container sizes, comprising:
a) at least one positional flow sensing device attached to at least one fluid control valve, providing fluid control valve positional information during dispensing of a fluid;
b) means for transfer of fluid control valve positional information to an electronic module including a controller;
c) means for removing acceleration from said fluid control valve positional information to obtain fluid flow information;
d) said electronic module including a controller unit operatively coupled to said one or more positional flow sensing devices indicating a mechanical movement of said one or more control valves;
e) a computing device and user interface for enabling a user to program said controller and/or a tap hub module, and for calculating and viewing accumulated flow volume information;
f) said user interface providing tabulated data indicating volume of liquid dispensed by known container sizes.

9. A fluid flow measuring system in accordance with claim 8, further comprising means for said user to print accumulated flow volume information.

10. A fluid flow measuring system in accordance with claim 8, wherein said at least one positional flow sensing device provides information to said controller to determine with reasonable accuracy a fluid volume dispensed when said fluid control valve is continuously moved from a closed to an open position at varying speeds.

11. A fluid flow measuring system in accordance with claim 10, wherein said controller is provided by a computer including:
a) wireless communication means for providing data to said tap hub module for tabulating or providing data to said computing device for display of information for viewing by a user;
b) a group of switches to allow said user to convey additional information to said controller, tap hub module, and said computing device; and
c) means for providing printed or saved tabulated fluid volume data.

12. A fluid flow measuring system in accordance with claim 11, wherein said group of switches is employable by an individual to configure said positional flow sensing device by indicating information to said controller, tap hub module, and computing device, including at least one of the following:
a) setting an enable to monitor a specific fluid flow control valve;
b) input information regarding service operation;
c) input information regarding keg change operation;
d) input information causing clearing of accumulated totals; and
e) causing a master reset event.

13. In a fluid dispensing system having a valve actuator movable along a predetermined path between a closed position and a fully open position, a flow sensing system comprising:
a) a sensor element mounted to a fluid control valve, comprising a positional indicator element interacting with the force of gravity, such that the state of said sensor element changes in accordance with a position of aid valve actuator along said predetermined path; and
b) a computer-based information handling and communication system coupled to said sensor element for detecting the state of said sensor element.

14. In the fluid dispensing system of claim 13, said computer-based information handling system further comprising a processor for calculating a fluid flow rate based on a detected state of said sensor element.

15. A fluid flow measuring system in accordance with claim 12, wherein said positional sensing device provides information to a software algorithm to determine with reasonable accuracy a volume dispensed when said fluid control valve is continuously moved from a closed to open position at varying speeds.

16. A fluid flow measuring system in accordance with claim 12, wherein a software algorithm is used to remove acceleration information from said positional information when said fluid control valve is continuously moved from a closed to open position at varying speeds.

17. In the fluid flow measuring system of claim 12, said positional flow sensing device comprising an accelerometer.

18. In the fluid flow measuring system of claim 12, said positional flow sensing device comprising an inclinometer.

19. An apparatus for dispensing liquid, comprising:
a) a dispensing valve having a manually operated valve actuator for controlling discharge of said liquid, said valve a actuator movable along a predetermined path between a closed position and a fully open position;
b) a position indicator element affixed to said actuator;
c) a sensor element mounted in a fixed position relative to said indicator element, said indicator element interacting with the force of gravity to vary a state thereof, such that the state of said sensor element varies in accordance with a position of said valve actuator along said predetermined path; and
d) a computer-based information handling system coupled to said sensor element for detecting said state of said sensor element.

20. A method for measuring a volume of fluid dispensed from a fluid dispensing system, comprising the step of:
calculating said dispensed volume based on input received from a sensor element mounted in a fixed position relative to an indicator element interacting with the force of gravity to vary a state thereof, said indicator element being affixed to an actuator of a liquid dispensing valve having a manually operated valve actuator for controlling discharge of said liquid, such that the state of said sensor element varies in accordance with a position of said valve actuator.

21. A method for accurately determining the instantaneous rate of fluid flow from a fluid dispensing valve, comprising the step of:
calculating a volume of fluid dispensed, based upon
a) the position of said fluid dispensing valve, as indicated by an analog position sensor affixed thereto;
b) dispensing container pressure;
c) supply line diameter;
d) supply line length;
e) and one or more additional factors selected from the group consisting of duration of a current pouring event, duration of a previous pouring event, calculated volume of a previous pouring event, time elapsed since a previous pouring event, and volume of fluid remaining in a fluid dispensing vessel.

22. The method of claim 21, wherein integration of instantaneous rate of flow calculated over the duration of a pouring event represents the volume of fluid dispensed from said fluid dispensing valve during said pouring event.
